(19) United States
(12) Patent Application Publication
(10) Pub. No.: US 2014/0347368 A1
(43) Pub. Date: Nov. 27, 2014

(54) NAVIGATION SYSTEM WITH INTERFACE MODIFICATION MECHANISM AND METHOD OF OPERATION THEREOF

(71) Applicant: Telenav, Inc., Sunnyvale, CA (US)

(72) Inventors: Sumit Kishore, San Jose, CA (US); Aliasgar Mumtaz Husain, Milpitas, CA (US)

(73) Assignee: Telenav, Inc., Sunnyvale, CA (US)

(21) Appl. No.: 13/899,441

(22) Filed: May 21, 2013

(51) Int. Cl. G01C 21/00; G06T 13/00

(52) U.S. Cl. CPC G01C 21/00; G06T 13/00
USPC 345/473; 701/400; 701/538

(57) ABSTRACT

A method of operation of a navigation system includes: aggregating context information for capturing a current context of a user; and modifying a navigation avatar based on the context information for displaying on a device.

### TECHNICAL FIELD

An embodiment of the present invention relates generally to a navigation system, and more particularly to a system for interface modification.

### BACKGROUND

Modern consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms are beginning to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world.” One such use of location based services is to efficiently transfer or route users to the desired destination or service.

Navigation systems and location based services enabled systems have been incorporated in automobiles, notebooks, handheld devices, and other portable products. Today, these systems aid users by incorporating available, real-time relevant information, such as maps, directions, local businesses, or other points of interest (POI). The real-time information provides invaluable relevant information.

However, user interface modification that reflects “real world” context and information has become a paramount concern for the consumer. Standard interface features provided by navigation systems do not accurately incorporate preferences and information that is important to the user, decreasing the benefit of using the tool.

Thus, a need still remains for a navigation system with interface modification mechanism based on destination guidance to incorporate information that is the most useful to the user. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a method of operation of a navigation system including: aggregating context information for capturing a current context of a user; and modifying a navigation avatar based on the context information for displaying on a device.

An embodiment of the present invention provides a navigation system, including: a context aggregation module for aggregating context information for capturing a current context of a user; and a modification application module, coupled to the context aggregation module, for modifying a navigation avatar based on the context information for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with interface modification mechanism in an embodiment of the present invention.

FIG. 2 is an example of a display interface of the first device of FIG. 1.

FIG. 3 is an exemplary block diagram of the navigation system.

FIG. 4 is a control flow of the navigation system.

FIG. 5 is a flow chart of a method of operation of a navigation system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

One skilled in the art would appreciate that the format with which image information is expressed is not critical to some embodiments of the invention. For example, in some embodiments, image information is presented in the format of (X, Y); where X and Y are two ordinates that define the geographic location, i.e. a position of a user.

In an alternative embodiment, navigation information is presented by longitude and latitude related information. In a further embodiment of the present invention, the navigation information also includes a velocity element including a speed component and a heading component.

The term “relative information” referred to herein comprises the navigation information described as well as information relating to points of interest to the user, such as local business, hours of business, types of business, advertised specials, traffic information, maps, local events, and nearby community or personal information.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

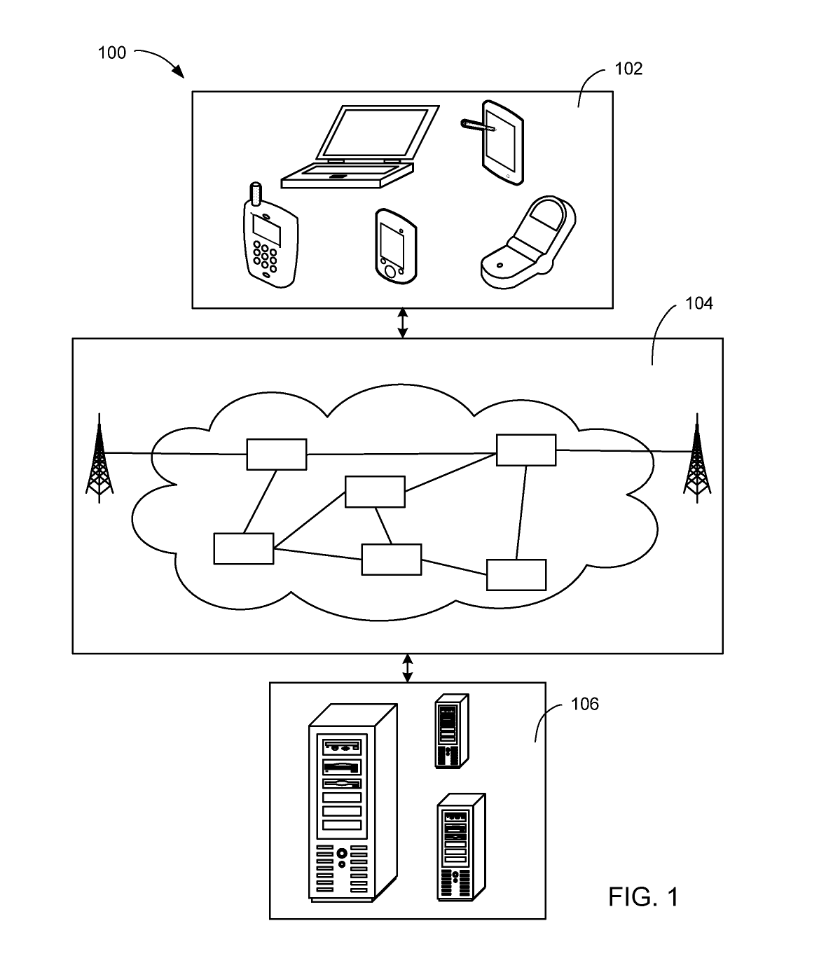

Referring now to FIG. 1, therein is shown a navigation system 100 with interface modification mechanism in an embodiment of the present invention. The navigation system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the navigation system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, grid-computing resources, a virtualized computer resource, cloud computing resource, routers, switches, peer-to-peer distributed computing devices, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the navigation system 100 is described with the second device 106 as a computing device, although it is understood that the second device 106 can be different types of devices. Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

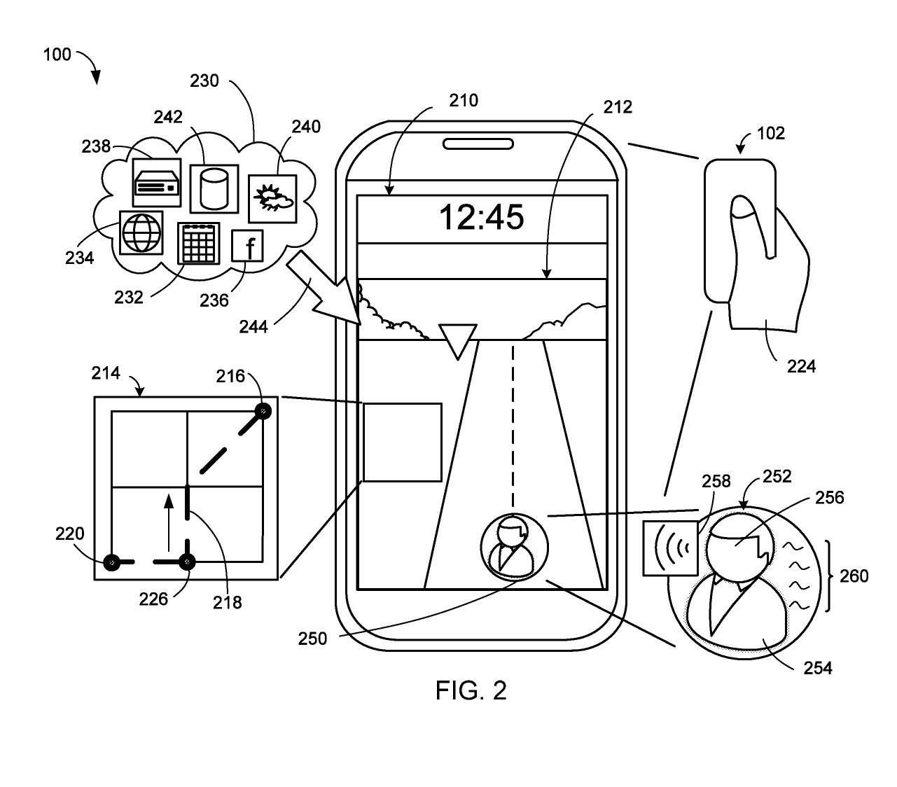

Referring now to FIG. 2, therein is shown an example of a display interface 210 of the first device 102 of FIG. 1. The navigation system 100 can display a navigation interface 212 on the display interface 210. The navigation interface 212 is defined as an interface that provides information for determining a location or guidance to a location. For example, the navigation interface 212 can present a navigation session 214 for the user 224.

The navigation session 214 is defined as a session that provides information about a location, navigation to a location, or any combination thereof. For example, the navigation session 214 can include a search by the user 224 to find a destination location 216 relative to the current location 226 of the user 224. In another example, the navigation session 214 can include display a travel route 218 between an initial location 220 of a user 224, the current location 226 of the user 224, or a combination thereof, and a destination location 216.

The initial location 220 is defined as the location at the beginning of the navigation session 214. The current location 226 is defined as the instantaneous position of the user while traveling along the route. The destination location 216 is defined as the ultimate location along a route. The travel route 218 is defined as the travel path between an initial location and a destination. For example, the travel route 218 can be the suggested route for travel between the initial location 220 and the destination location 216.

The navigation system 100 can include context information 230 associated with the user 224. The context information 230 is defined as information associated with the location, activities, preferences, habits, relationships, status, surroundings, or any combination thereof of the user 224. The context information 230 can include a temporal context 232, a spatial context 234, a social context 236, a historical context 238, a global context 240, a user context 242, or a combination thereof.

The temporal context 232 is defined as information or events associated with the time of day, date, time of year, or season. For example, the temporal context 232 can be the time and date of the navigation session 214. In another example the temporal context 232 can be the time associated with the end of the work day or the time associated with a meal, such as lunch or dinner.

The spatial context 234 is defined as information related to the motion or location of the user. For example, the spatial context 234 can be information about the current location 226 of the user 224 or the speed at which the user 224 is traveling at the time of the navigation session 214.

The social context 236 is defined as information related personal relationships and activities of the user. The social context 236 can include information, such as the current location or activities of friends of the user 224.

The historical context 238 is defined as behavioral patterns or habits of the user. For example, the historical context 238 can include routes typically taken by the user 224, the time of day the user 224 typically travels, or frequently visited locations. The historical context 238 can be observed, inferred, or learned patterns or habits.

The global context 240 is defined as events occurring during, concurrently, or within close temporal proximity with the navigation event. For example, the global context 240 can include current or real time information, such as the current weather, news reports, traffic along the travel route, or sporting events.

The user context 242 is defined as personal information and preferences of the user. For example, the user context 242 can include information, such as preferred cuisines or restaurants, music genres or artists, sports teams, brands, shops, or stores.

The navigation system 100 can modify the navigation interface 212 with interface customizations 244 that incorporate the context information 230. The interface customizations 244 are defined as modifications to the standard or stock user interface based on context of the user. The interface customizations 244 can be based on the context information 230 associated with the user 224.

The navigation system 100 can include a navigation avatar 250. The navigation avatar 250 is defined as a customizable representation of the user that incorporates real time information about the user in the real world. For example, the navigation avatar 250 can be a virtual representation or likeness of the user 224 that reflects the current preferences, moods, emotions, or status of the user 224. The navigation avatar 250 can be selected by the user 224 or automatically generated by the navigation system 100. The navigation avatar 250 can be a digital representation or likeness of the user 224. Alternatively, the navigation avatar 250 can be an object that the user 224 choses to represent the user 224, such as a depiction of the vehicle driven by the user 224. The navigation system 100 can present a navigation avatar 250 on the display interface 210 of the first device 102.

The navigation system 100 can modify the navigation avatar 250 based the context information 230 by changing, modifying, or adjusting avatar characteristics 252 of the navigation avatar 250. The avatar characteristics 252 can include avatar attire 250, an avatar expression 256, an avatar audio component 258, an avatar animation 260, or a combination thereof.

The avatar attire 250 is clothing and accessories adorned by the navigation avatar 250. For example, the avatar attire 250 can include articles of clothing, such as shirts, suits, and pants, and accessories, such as jewelry, hats, shoes, and glasses.

The avatar expression 256 is the facial expression, posture, or body language of the navigation avatar 250. The avatar expression 256 can reflect the current mood of the user 224. For example, the avatar expression 256 can be displayed having a frazzled hair style when the user 224 is annoyed or frustrated. In another example, the avatar expression 256 can be displayed as a smiling facial expression when the user 224 is in a good mood. In yet a further example the avatar expression 256 can be displayed having a posture or body language of slumped shoulders when the user is frustrated or tired.

The avatar audio component 258 is the sound effects associated with the navigation avatar 250. The avatar audio component 258 can be sounds effects or speech that reflects the current mood or status of the user 224, information related to navigation, or preferences of the user 224. For example, the avatar audio component 258 can be a yawning sound when the user 224 is tired or a grumbling sound when the user is frustrated. In another example, the avatar audio component 258 can include announcements, such as navigation directions or news updates based on the preference of the user 224.

The avatar animation 260 is the motion and gestures made by the navigation avatar 250. For example, the avatar animation 260 can include animation or movement of the avatar expression 256, the avatar attire 250, or a combination thereof.

The navigation system 100 can modify the navigation interface 212, the navigation avatar 250, or a combination thereof based on the context information 230 in a number of different ways. As an illustration, in the situation where the user 224 is traveling to the destination location 216 of a restaurant, various aspects of the context information 230 can be available to the navigation system 100 for modification of the navigation interface 212, the navigation avatar 250, or a combination thereof.

For instance, the social context 236 can include locations of friends, but not work colleagues, of the user 224 with a similar demographic who check into a restaurant. The spatial context 234 can include information about the restaurant, such as the address, distance from the current location 226 of the user 224, and the restaurant type. The global context 240 can include information about the weather. The temporal context 232 can include temporal information at the time of the navigation session, such as whether the day is a workday, and events associated with the time of the navigation session, such as whether it is breakfast time, lunch time, or dinner time.

To continue the illustration, the navigation interface 212 can be modified to integrate the context information 230 related to navigation to a restaurant. For example, points of interest along the travel route 218 associated with the context information 230, such as restaurants, can be highlighted by animation or increased size. In another example, the travel route 218 can be modified with the destination location 216 as the restaurant where the social context 236 indicates that the friend of the user 224 is eating lunch. In yet a further example, the navigation interface 212 can be modified to take the appearance of a lunch theme, which can include icons, decorations, or graphic enhancements for restaurants favored by the user 224, as indicated by the user context 242 and sound effects of cooking food, such as the sizzle of a hamburger on a grill.

To further the illustration, the avatar characteristics 252 of the navigation avatar 250 can be modified to integrate the context information 230 related to navigation to a restaurant. As an example, the navigation system 100 can modify the navigation avatar 250 to complement the navigation interface 212. In another example, the avatar animation 260 can be modified to show the navigation avatar 250 eating a hamburger when the social context 236 or user context 242 indicates preference for American food. In a further example, when the temporal context 232 indicates the navigation event occurs during a work day, the avatar attire 250 can be modified or embellished with a work uniform or business clothes and a napkin around the neck of the navigation avatar 250.

As another illustration, in the situation where the user 224 is searching for or navigating to the destination location 216 of a bank or ATM machine, various aspects of the context information 230 can be available to the navigation system 100 for modification of the navigation interface 212, the navigation avatar 250, or a combination thereof.

For instance, the user context 242 can include information related to the preferred bank of the user 224. The historical context 238 can include information related to the frequency or patterns of when the user 224 visits the bank or ATM.

To continue the illustration, the navigation interface 212 can be modified to integrate the context information 230 related to the search of navigation to a bank or ATM machine. For example the navigation interface 212 can be embellished by animation or increased size to highlight the points of interest of banks or ATM machines near the current location 226 of the user 224. In another example, the navigation interface 212 can include sound effects of a cash register or the clinking of coins.

To further the illustration, the avatar characteristics 252 of the navigation avatar 250 can be modified to integrate the context information 230 related to the search of navigation to a bank or ATM machine. For example, the avatar expression 256 can be modified or embellished such that the eyes of the navigation avatar 250 shows “$” signs. In another example, the avatar attire 250 can be modified or embellished to show the navigation avatar 250 holding money. In yet another example, the avatar animation 260 can be modified to show the navigation avatar 250 withdrawing or receiving cash from a bank.

Another possible realization can involve navigation to an ATM for money withdrawal. The signals in this case can be user's frequency of ATM visits (accumulated behavioral), time of ATM visits (accumulated behavioral), preferred bank voluntarily disclosed (stored preferences) or inferred (social context), when the user is in motion (sensory) in proximity to an ATM (location, sensory). The interface customization can be manifested as the avatar being embellished with animated ‘$’ signs in the eyes, with Bank POIs being visually distinguished by highlights, increased size and animations (e.g. money being withdrawn) in the UI and with an audio notification in the form of a “cha-ching” sound.

In yet a further illustration, in the situation where navigation along the travel route 218 occurs during the season of a particular sport or a sporting event, various aspects of the context information 230 can be available to the navigation system 100 for modification of the navigation interface 212, the navigation avatar 250, or a combination thereof.

For instance, if the user context 242, the social context 236, or a combination thereof can include information about the favorite team or athlete of the user 224. The temporal context 232 can include information about the time and duration of the sporting event. The global context 240 can include information about the sporting event, such as the score. The temporal context 232 and the user context 242 can include information related to the work hours of the user 224.

To continue the illustration, the navigation interface 212 can be modified to integrate the context information 230 during a particular sports season. For example, the navigation interface 212 can be modified to display icons or logos for the favorite team of the user 224. In another example, when the temporal context 232 and the user context 242 indicates that the user 224 is not working, the navigation interface 212 can be modified to include sports themed sound effects, such as team slogans or chants and navigation prompts tailored to sound like a sports commentator or announcer.

To further the illustration, the avatar characteristics 252 of the navigation avatar 250 can be modified to integrate the context information 230 during a particular sports season. For example, the avatar attire 250 can be modified or embellished with the jersey, hat, or helmet of a particular team or athlete. In another example, the avatar animation 260 and the avatar audio component 258 can be modified to cheer when the favorite team of the user 224 scores a point or goal.

The navigation system 100 can be configured to dismiss or remove the modifications to the navigation interface 212. For example, the navigation system 100 can interactively dismiss the navigation interface 212 when the user 224 performs a specific gesture, such as a left to right waving motion.

As an example, the navigation system 100 can interactively dismiss the interface customizations 244. As a specific example, the user 224 can dismiss or cancel the interface customizations 244 of the navigation interface 212 through a gesture, such as a hand wave.

The navigation system 100 can be configured to integrate or display the navigation avatar 250 of further device (not shown), such as the device of a friend that is traveling with the user 224. For example, the display interface 210 can present both the navigation avatar 250 of the user 224 and the navigation avatar 250 of a friend or the user 224.

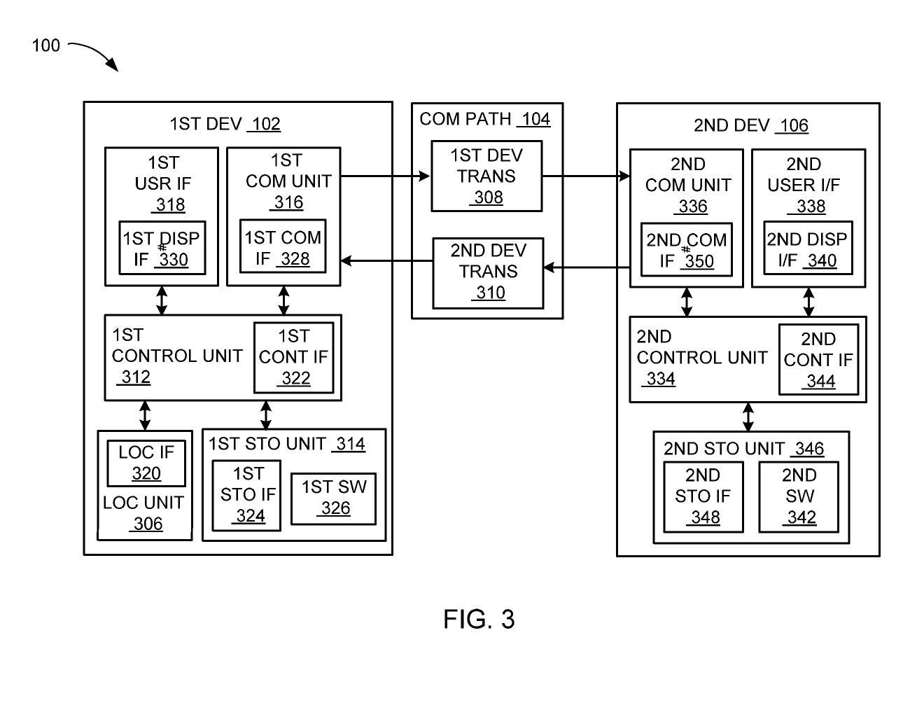

Referring now to FIG. 3, therein is shown an exemplary block diagram of the navigation system 100. The navigation system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server having a display interface.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, a first user interface 318, and a location unit 320. The first control unit 312 can include a first control interface 322. The first control unit 312 can execute a first software 326 to provide the intelligence of the navigation system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The location unit 320 can generate location information, current heading, and current speed of the first device 102, as examples. The location unit 320 can be implemented in many ways. For example, the location unit 320 can function as at least a part of a global positioning system (GPS), an inertial navigation system, a cellular-tower location system, a pressure location system, or any combination thereof.

The location unit 320 can include a location interface 332. The location interface 332 can be used for communication between the location unit 320 and other functional units in the first device 102. The location interface 332 can also be used for communication that is external to the first device 102.

The location interface 332 can include different implementations depending on which functional units or external units are being interfaced with the location unit 320. The location interface 332 can be implemented with technologies similar to the implementation of the first control interface 322.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user to interface and interact with the first device 102. The first user interface 318 can include an input device and an output device. Examples of the input device of the first user interface 318 can include a keypad, a touchpad, soft-keys, a keyboard, camera, video recorder, a microphone, an infrared sensor for receiving remote signals, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the navigation system 100. The first control unit 312 can also execute the first software 326 for the other functions of the navigation system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the navigation system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the navigation system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the navigation system 100 is shown with the second storage unit 346 as a single hierarchy storage system, although it is understood that the navigation system 100 can have the second storage unit 346 in a different configuration. For example, the second storage unit 346 can be formed with different storage technologies forming a memory hierarchical system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The navigation system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100.

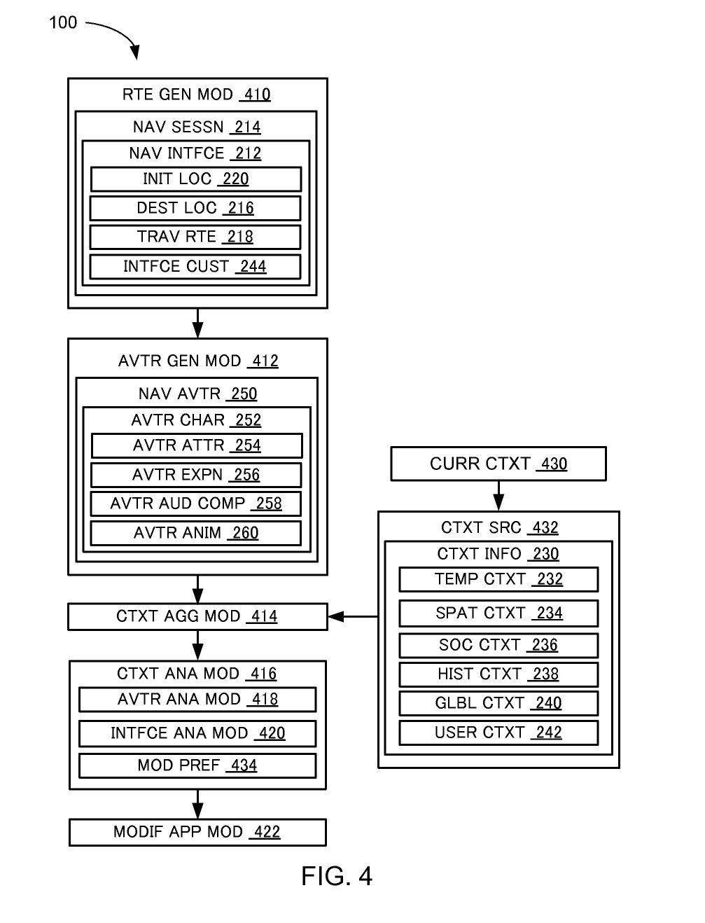

Referring now to FIG. 4, therein is shown a control flow of the navigation system 100. The navigation system 100 can include a route generation module 410, an avatar generation module 412, a context aggregation module 414, a context analysis module 416, and a modification application module 422. As an example, the route generation module 410 can be coupled to the context aggregation module 414. In another example, the context aggregation module 414 can be coupled to the context analysis module 416. In yet another example, the context analysis module 416 can be coupled to the modification application module 422. In yet a further example, the avatar generation module 412 can be coupled to the context aggregation module 414.

The route generation module 410 is for generating a route between an origin location and a final location. The route generation module 410 can generate the travel route 218 from the initial location 220 to the destination location 216. For example, the route generation module 410 can calculate or plot the travel route 218 between the initial location 220 to the destination location 216 based on the longitudinal and latitudinal coordinates or the street address of the initial location 220 to the destination location 216.

The avatar generation module 412 is for creating an avatar as a representation of the user. The avatar generation module 412 can automatically generate the navigation avatar 250 or enable the user to manually generate or select the navigation avatar 250. For example, the avatar generation module 412 can be automatically extract images or portraits from online source, such as a social media website or databases, such as Facebook™, Yelp™, Foursquare™, Google+™, or Instagram™.

In another example, the avatar generation module 412 can enable the user 224 to create or select the navigation avatar 250. As a specific example, the avatar generation module 412 can implement the image capture device of the first user interface 318 of FIG. 3 to capture an image of the user 224 to generate the navigation avatar 250. In another specific example, the avatar generation module 412 can enable the user 224 to select or import an image as the navigation avatar 250 from online source, such as a social media website or databases, such as Facebook™, Yelp™, Foursquare™, Google+™, Linkedin™, or Instagram™.

The avatar generation module 412 can generate the navigation avatar 250 to include the avatar characteristics 252. For example, the avatar generation module 412 can generate a two-dimensional or three-dimensional rendering of the user 224 that can express the avatar characteristics 252, such as the avatar attire 250, an avatar expression 256, an avatar audio component 258, an avatar animation 260, or a combination thereof. The avatar generation module 412 can generate the navigation avatar 250 in the likeness of the user 224.

The context sources 432 are sources of information that capture the context of the user at a given point in time. For example, the context sources 432 can be the various sources that capture or store a current context 430 of the user 224. The current context 430 is the location, activities, preferences, habits, relationships, status, surroundings, or any combination thereof of the user at the time of the navigation session 214.

As an example, the context sources 432 can include modules or hardware units onboard the first device 102. In a specific example, the context sources 432 can include the global positioning unit in the location unit 320 of FIG. 3. In another specific example, the context sources 432 can include the calendar, task list, or contact list stored in the first storage unit 314 of FIG. 3. In yet another specific example, the context sources 432 can include information derived from the first software 326, such as a clock application or a machine learning program that can track movement and behavior by the user 224 to deduce the person's patterns, including work hours and when meals are taken, or navigational patterns, including frequent destinations, routes traveled, or preferred location types.

As a further example, the context sources 432 can include online or internet based sources. As a specific example, the context sources 432 can include social network website such as Facebook™, Yelp™, Foursquare™, Google+™, Linkedin™, or Instagram™. As another specific example, the context sources 432 can include e-mail servers. In yet a further specific example, the context sources 432 can include informational websites for weather, sports, or news. In yet a further specific example, locations and addresses for navigation to the destination location 216 to can be deduced or extracted from analysis of an e-mail account of the user 224 email.

The context information 230 can include the temporal context 232, the spatial context 234, the social context 236, the historical context 238, the global context 240, the user context 242, or any combination thereof.

The context aggregation module 414 can aggregate the temporal context 232, the spatial context 234, the social context 236, the historical context 238, the global context 240, and the user context 242, of the context information 230 to capture the current context 430 of the user 224 from the context sources 432. For example, the context aggregation module 414 can aggregate the temporal context 232 from the hardware unit onboard the first device 102, such as a clock or calendar stored in the first storage unit 314. In another example, the context aggregation module 414 can aggregate the spatial context 234 the hardware unit, such as the location unit 320 or from an online data base, such as Google Maps™.

In a further example, the context aggregation module 414 can aggregate the social context 236 from one or more online sources, such as the social network website or e-mail, or information stored in the first storage unit 314, such as a contact list of the user 224. Similarly, the global context 240 can be aggregated by the context aggregation module 414 from online sources, such as news, sports, or weather websites.

In yet a further example the context aggregation module 414 can aggregate the user context 242 or the historical context 238 derived from the first software 326 or the second software 342 of FIG. 3, such as a machine learning program or application, and stored in the first storage unit 314 or the second storage unit 346 of FIG. 3. Alternatively, the context aggregation module 414 can aggregate the user context 242 or the historical context 238 online sources, such as the social network website or e-mail.

The context analysis module 416 is for analyzing the information associated with the context of the user to determine whether the interface, avatar, or a combination thereof can be modified based on the context. The context analysis module 416 can analyze the context information 230 to determine when the context information 230 can be applied to modify the avatar characteristics 252 of the navigation avatar 250, the interface customizations 244 of the navigation interface 212, or a combination thereof. The context analysis module 416 can analyze the context information 230 with respects to the navigation avatar 250 and the navigation interface 212 with an avatar analysis module 418 and an interface analysis module 420, respectively. The avatar analysis module 418 and the interface analysis module 420 can be coupled to the modification application module 424.

The avatar analysis module 418 can check the temporal context 232, the spatial context 234, the social context 236, the historical context 238, the global context 240, and the user context 242, either singly or in combination, to determine whether associated information of the respective ones of the context information 230 can be applied to modify the avatar characteristics 252 of the navigation avatar 250. For example, the avatar analysis module 418 can compare each context of the context information 230 with the avatar attire 250, the avatar expression 256, the avatar audio component 258, and the avatar animation 260 of the avatar characteristic 252 to determine whether the context information 230 can be applied to the avatar characteristic 252.

As a specific example, the avatar characteristics 252 can be modified to correspond with or is specific to the spatial context 234, including travel to the destination location 216. For instance, when the spatial context 234 indicates that the user 224 is driving to the destination location 216, the avatar analysis module 418 can determine that the avatar expression 256 and the avatar animation 260 can be modified to express motion and the avatar attire 254 correspond with or are specific to the destination location 216. In another specific example, when the spatial context 234 indicates that the user 224 is driving to the destination location 216, but is not in motion, the avatar analysis module 418 can determine the spatial context 234 does not have proper context to modify the avatar characteristics 252.

The avatar analysis module 418 can utilize a modification preference 434 to determine when one of the contexts of the context information 230 will be superseded or preferred over another one of the context of the context information 230. The modification preference 434 can be predetermined as a default setting or can be set by the user 224 according to the preference of the user 224.

As an example, the avatar analysis module 418 can compare one instance of the context information 230 and another instance of the context information 230 to the modification preference 434 to determining which instance of the context information 230 will be used for modifying the avatar characteristics 252 of the navigation avatar (250). As a specific example, when the temporal context 232 indicates that the user 224 is traveling along the travel route 218 during work hours, and the global context 240 indicates that the favorite team of the user 224 is currently playing a game, the modification preference 434 can be set to determine that the avatar attire 254 should present work clothes rather than clothes representing the team. In another specific example, when the user context 242 indicates that the user 224 has a business meeting scheduled and the temporal context 232 and historical context 238 indicate that the user 224 typically eats lunch at that time, the modification preference 434 can determine that the avatar characteristics 252 will not be modified to reflect meal time.

The interface analysis module 420 can check the temporal context 232, the spatial context 234, the social context 236, the historical context 238, the global context 240, and the user context 242, either singly or in combination, to determine whether associated information of the respective ones of the context information 230 can be applied to modify the interface customizations 244 of the navigation interface 212. For example, when the temporal context 232 indicates that it is day time and the global context 240 indicates that the weather is partly cloudy, the interface analysis module 420 can determine that the interface customization 244 can include weather that reflects sunshine that is partially obscured by clouds. In another example, when the user context 242 indicates that the user 224 has a business meeting scheduled and the temporal context 232 and historical context 238 indicate that the user 224 typically eats lunch at that time, the modification preference 434 can determine that the interface customization 244 will not be modified to reflect a lunch time theme.

The modification application module 422 can modify the navigation avatar 250 and the navigation interface 212. For example, when the avatar analysis module 418 or the interface analysis module 420 of the context analysis module 416 indicates that the context information 230 can be applied to modify the navigation avatar 250 and the navigation interface 212, the navigation system 100 can apply appropriate modifications to the navigation avatar 250 and the navigation interface 212.

As a specific example, the navigation interface 212 can display modifications to the travel route 218 based on a combination of the historical context 238 and the user context 242. When the historical context 238 and the user context 242 indicates that the user 224 prefers or typically selects the travel route 218 that is fastest and avoids highways during periods of heavy traffic, the modification application module 422 can modify the navigation interface 212 to display the travel route 218 that is fastest and avoids highways.

In another specific example, modification application module 422 can apply modifications to the avatar animation 260 of the navigation avatar 250 based on the spatial context 234 when traveling along the travel route 218. For example, when the spatial context 234 indicates that the user 224 is traveling at high speeds, the modification application module 422 can modify the avatar animation 260 to show the hair of the navigation avatar 250 blowing in the wind.

It has been discovered that the navigation system 100 provides interactive representation of the user 224. The context information 230, which represents at least the real world status and activities of the user 224, can be integrated into the navigation system 100 with the context analysis module 416 to modify the navigation interface 212 and navigation avatar 250 to provide the interactive representation of the user 224.

The navigation system 100 has been described with module functions or order as an example. The navigation system 100 can partition the modules differently or order the modules differently. For example, the first control unit 316 can execute the avatar generation module 412, the context analysis module 416, and the modification application module 422 to generate and modify the navigation avatar 250 and the second control unit 388 can execute the route generation module 410 to generate the travel route 218, the context aggregation module 414 to aggregate the context information 230, or any combination thereof.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

The physical transformation from the context information 230 that represents the current context 430 of the user 224 to modify the navigation avatar 250 and the navigation interface 212 results in the movement in the physical world, such as the user 224 using the navigation interface 212 to travel along the travel route 218. Movement in the physical world results in changes to the current context 430 of the user 224 which in turn further modifies the navigation avatar 250 and the navigation interface 212.

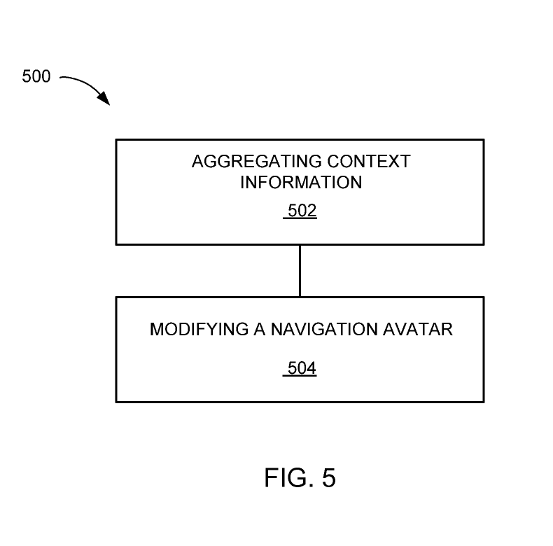

Referring now to FIG. 5, therein is shown a flow chart of a method 500 of operation of a navigation system 100 in an embodiment of the present invention. The method 500 includes: aggregating context information for capturing a current context of a user in a block 502; and modifying a navigation avatar based on the context information for displaying on a device in a block 504.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method of operation of a navigation system comprising:
aggregating context information for capturing a current context of a user; and
modifying a navigation avatar based on the context information for displaying on a device.

2. The method as claimed in claim 1 further comprising comparing one instance of the context information and a further instance of the context information to a modification preference for modifying the navigation avatar.

3. The method as claimed in claim 1 further comprising comparing the context information and an avatar characteristic of the navigation avatar to determine whether the context information is applicable for modifying the avatar characteristic.

4. The method as claimed in claim 1 wherein modifying the navigation avatar includes modifying the navigation avatar to correspond with a spatial context of the context information.

5. The method as claimed in claim 1 wherein aggregating the context information includes aggregating the context information from a context source.

6. A method of operation of a navigation system comprising:
generating a travel route;
aggregating context information for capturing a current context of a user; and
modifying a navigation avatar, for representing travel along the travel route, based on the context information for displaying on a device.

7. The method as claimed in claim 6 further comprising modifying a navigation interface associated with the travel route based on the context information.

8. The method as claimed in claim 6 wherein modifying the navigation avatar includes modifying the navigation avatar to complement a navigation interface associated with the travel route.

9. The method as claimed in claim 6 wherein modifying the navigation avatar includes modifying the navigation avatar based on a spatial context of the context information.

10. The method as claimed in claim 6 further comprising generating the navigation avatar having avatar characteristics, including an avatar attire and an avatar expression.

11. A navigation system comprising:
a context aggregation module for aggregating context information for capturing a current context of a user; and
a modification application module, coupled to the context aggregation module, for modifying a navigation avatar based on the context information for displaying on a device.

12. The system as claimed in claim 11 further comprising an avatar analysis module, coupled to the modification application module for comparing one instance of the context information and a further instance of the context information to a modification preference for modifying the navigation avatar.

13. The system as claimed in claim 11 further comprising a context analysis module, coupled to the context aggregation module, for comparing the context information and an avatar characteristic of the navigation avatar to determine whether the context information is applicable for modifying the avatar characteristic.

14. The system as claimed in claim 11 further comprising an avatar analysis module 418, coupled to the modification application module, for modifying the navigation avatar to correspond with a spatial context of the context information.

15. The system as claimed in claim 11 wherein the context aggregation module is for aggregating the context information from a context source.

16. The system as claimed in claim 11 further comprising:
a route generation module, coupled to the context aggregation module, for generating a travel route; and
an avatar generation module, coupled to the context aggregation module, for selecting the navigation avatar for representing travel along the travel route.

17. The system as claimed in claim 16 wherein the modification application module is for modifying a navigation interface associated with the travel route based on the context information.

18. The system as claimed in claim 16 wherein the modification application module is for modifying the navigation avatar to complement a navigation interface associated with the travel route.

19. The system as claimed in claim 16 wherein the modification application module is for modifying the navigation avatar based on a spatial context of the context information.

20. The system as claimed in claim 16 wherein the avatar generation module is for generating the navigation avatar having avatar characteristics, including an avatar attire and an avatar expression.
